(19) United States
(12) Patent Application Publication
(10) Pub. No.: US 2026/0155603 A1
(43) Pub. Date: Jun. 4, 2026

(54) LEVER-TYPE CONNECTOR

(71) Applicant: YAZAKI CORPORATION, Tokyo (JP)

(72) Inventors: Yasuhiro Sasaki, Makinohara-shi (JP); Yukiya Ishida, Makinohara-shi (JP)

(21) Appl. No.: 19/405,166

(22) Filed: Dec. 1, 2025

(30) Foreign Application Priority Data
Dec. 3, 2024 (JP) 2024-210041

(51) Int. Cl. H01R 13/629

(52) U.S. Cl. CPC H01R 13/62933

(57) ABSTRACT

A lever-type connector according to an embodiment includes a housing that is capable of being mated with a male housing, and a lever that is assembled to the housing and is movable from an initial position to a mating position. The lever includes a restricting portion that is capable of being assembled to the housing at an assembly position and is capable of restricting movement from the initial position to the assembly position. The housing includes a locking arm elastically deformable in response to the first restricting portion. The locking arm includes a locking portion capable of abutting a second edge portion of the first restricting portion in a state where the lever is disposed at the initial position, and an inclined surface capable of abutting the first edge portion of the first restricting portion in a state where the lever is disposed at the assembly position.

### BACKGROUND OF THE INVENTION

### Field of the Invention

The embodiments of the present invention relate to a lever-type connector.

Priority is claimed on Japanese Patent Application No. 2024-210041 filed in Japan on December 3, 2024, the content of which is incorporated herein by reference.

### Description of the Related Art

As the lever-type connector, for example, lever-type connectors disclosed in Patent Document 1 and Patent Document 2 are known. In this lever-type connector, a lever is movably provided in a housing, and the lever is moved from an initial position to a mating position in a state where the housing is mated with another housing.

### Prior art document

### Patent document

Patent Document 1: Japanese Unexamined Patent Application, First Publication No. 2018-206648

Patent Document 2: Japanese Unexamined Patent Application, First Publication No. 2019-8915

### SUMMARY OF THE INVENTION

However, in the lever-type connectors of Patent Document 1 and Patent Document 2, for example, when the lever is assembled to the housing, the lever is assembled to the housing in a state where the lever is disposed between the initial position and the mating position. With such a constitution, for example, when the mating of the housing is assisted by moving the lever from the initial position to the mating position, it may be difficult to secure the lever in a state of being held on the housing.

An embodiment provides a lever-type connector capable of enhancing the retention of the lever with respect to the housing.

According to an embodiment, there is provided a lever-type connector including: a housing that is capable of being mated with another housing; and a lever that is assembled to the housing and is movable from an initial position before start of mating with the another housing to a mating position after completion of the mating, in which the lever includes a restricting portion that is capable of being assembled to the housing at an assembly position of the housing and is capable of restricting movement from the initial position to the assembly position, the housing includes a locking arm that is elastically deformable in response to the restricting portion, and the locking arm includes a locking portion that protrudes toward the restricting portion and is capable of abutting an edge portion of the restricting portion in a state where the lever is disposed at the initial position, and an inclined surface that tapers the locking portion and is capable of abutting the edge portion of the restricting portion in a state where the lever is disposed at the assembly position.

According to the embodiment, it is possible to enhance the retention of the lever with respect to the housing.

### BRIEF DESCRIPTION OF THE DRAWINGS

FIG. 1 is a perspective view illustrating a lever-type connector according to a first embodiment.

FIG. 2 is a side view illustrating a state where a lever is disposed at an assembly position in a lever-type connector according to the first embodiment.

FIG. 3 is a side view illustrating a state where a lever is disposed at an initial position in a lever-type connector according to the first embodiment.

FIG. 4 is an exploded side view of a lever-type connector according to the first embodiment.

FIG. 5 is a perspective view of a housing according to the first embodiment as viewed from the rear.

FIG. 6 is a cross-sectional view taken along line VI-VI in FIG. 2.

FIG. 7 is a cross-sectional view taken along line VII-VII in FIG. 2.

FIG. 8 is a perspective view of a lever-type connector according to the first embodiment in a state where a lever is disposed at an initial position as viewed from the rear.

FIG. 9 is a cross-sectional view taken along line IX-IX in FIG. 3.

FIG. 10 is a perspective view illustrating a state where a locking arm elastically deforms in a lever-type connector according to the first embodiment.

FIG. 11 is a side view illustrating a lever-type connector according to a second embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. The constitutions which will be described below do not limit the scope of the embodiment.

### First Embodiment

### Lever-Type Connector

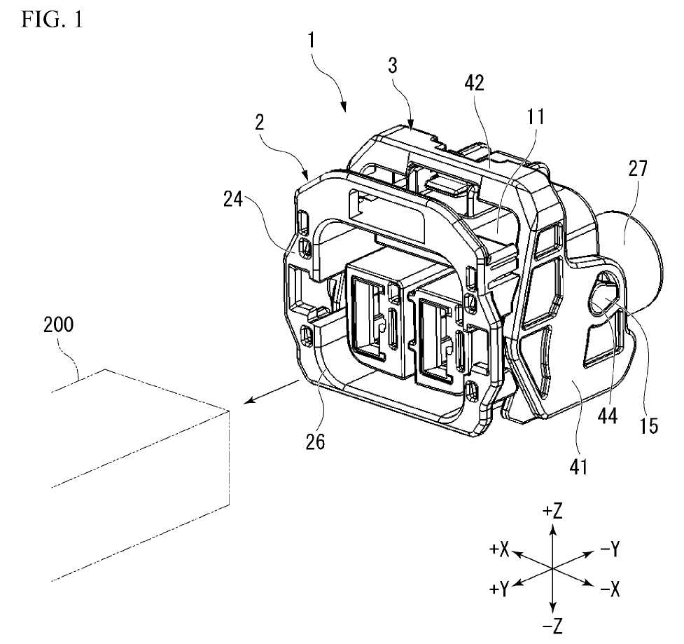

As illustrated in FIG. 1, a lever-type connector 1 can be connected to a male housing 200, for example, by being mated with the male housing 200 as another housing. The lever-type connector 1 includes, for example, a housing 2 and a lever 3.

The housing 2 is, for example, a female housing that can be mated with the male housing 200 in a first axial direction. The first axial direction is an axial direction of the housing 2. The housing 2 is mated with the male housing 200 from an opening 26 of a housing body 11. In the housing body 11, an electric wire 27 extends from the opposite side of the opening 26 in the first axial direction. When the housing 2 is mated with the male housing 200, the terminal of the housing 2 is connected to the terminal of the male housing 200. In the first embodiment, the housing 2 will be described by using a female housing as an example, but the housing 2 may be a male housing.

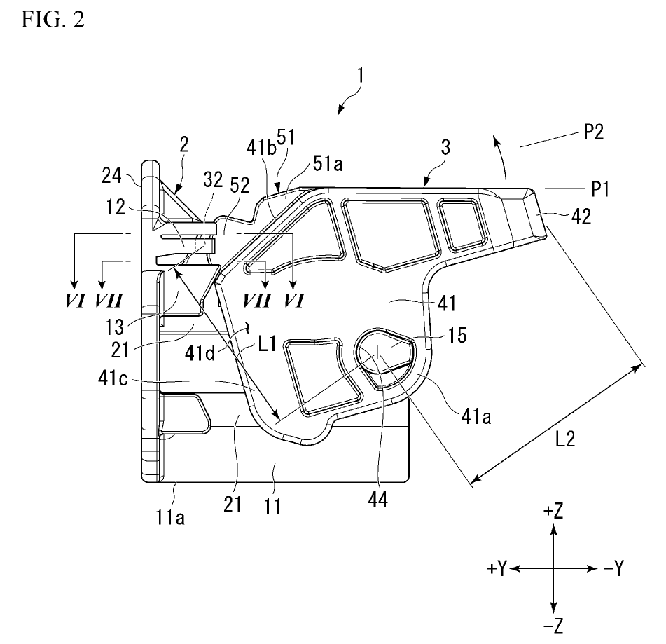

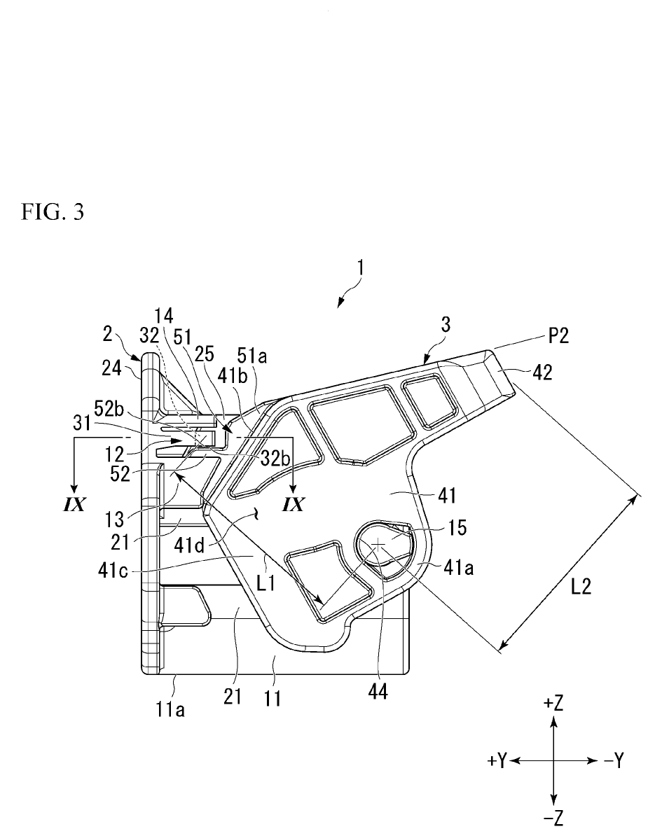

As illustrated in FIGS. 2 and 3, the lever 3 is disposed so as to straddle the housing 2. The lever 3 is rotatably attached to a pair of support bosses 15 (one support boss is illustrated) provided on the housing 2. The lever 3 is movable from an assembly position P1 to an initial position P2 about the pair of support bosses 15. The lever 3 is movable from the initial position P2 to a mating position (not illustrated), and is movable from the mating position to the initial position P2. The lever 3 is restricted from moving from the initial position P2 to the assembly position P1.

The assembly position P1 is a position where the lever 3 is assembled to the housing 2. The initial position P2 is a position of the lever 3 in a state before the housing 2 is mated with the male housing 200 (a position before the start of mating with the male housing 200). The mating position is a position of the lever 3 in a state after the housing 2 is mated with the male housing 200 (a position after the completion of mating with the male housing 200).

In the present disclosure, an X direction, a +X direction, a -X direction, a Y direction, a +Y direction, a -Y direction, a Z direction, a +Z direction, and a -Z direction are defined as follows.

The X direction is a direction orthogonal to the first axial direction of the housing 2 and a direction along a second axial direction of the pair of support bosses 15. The +X direction is a direction on the left side in the X direction as viewed from the opening 26 of the housing body 11. The -X direction is a direction on the right side in the X direction as viewed from the opening 26. Hereinafter, the +X direction and the -X direction are simply referred to as “X direction” in a case where they are not distinguished from each other.

The Y direction is the first axial direction of the housing 2. The +Y direction is a direction of the opening 26 of the housing body 11 in the Y direction. The -Y direction is a direction on the side opposite the opening 26 in the Y direction. Hereinafter, the +Y direction and the -Y direction are simply referred to as “Y direction” in a case where they are not distinguished from each other.

The Z direction is a direction intersecting the X direction and the Y direction. The +Z direction is a direction on the side where a connection portion 42 of the lever 3 is disposed. The -Z direction is a direction opposite the side where the connection portion 42 of the lever 3 is disposed. Hereinafter, in a case where the +Z direction and the -Z direction are not distinguished, the directions are simply referred to as “Z direction”.

Hereinafter, the +X direction side may be referred to as “left”, the -X direction side may be referred to as “right”, the +Y direction may be referred to as “front”, and the -Y direction may be referred to as “rear”. The +Z direction side may be referred to as “upper”, and the -Z direction side may be referred to as “lower”. The first axial direction of the housing 2 may be simply referred to as a “first axial direction”. However, these expressions are expressions for convenience of description, and do not limit the attachment orientation of the lever-type connector 1.

### Constitution of Housing

A detailed constitution of the housing 2 will be described.

As illustrated in FIGS. 1 to 5, the housing 2 includes, for example, a housing body 11, a pair of locking arms 12, a pair of restraining walls 13, a pair of stoppers 14, and a pair of support bosses 15. The pair of locking arms 12, the pair of restraining walls 13, the pair of stoppers 14, and the pair of support bosses 15 are each bilaterally symmetrical members. Hereinafter, the right member of each of the pair of locking arms 12, the pair of restraining walls 13, the pair of stoppers 14, and the pair of support bosses 15 will be described, and the description of the left member will be omitted. The right locking arm 12, the right restraining wall 13, the right stopper 14, and the right support boss 15 will be collectively referred to as a “locking arm 12”, a “restraining wall 13”, a “stopper 14”, and a “support boss 15”, respectively.

The housing body 11 includes a pair of side walls 21, a top portion 22, a bottom portion 23, and a flange portion 24. The pair of side walls 21 are disposed apart from each other in a left-right direction. The top portion 22 connects the upper sides of the pair of side walls 21. The bottom portion 23 connects the lower sides of the pair of side walls 21. The housing body 11 is formed in a substantially rectangular frame cross section by the pair of side walls 21, the top portion 22, and the bottom portion 23. The housing body 11 has an opening 26 (see FIG. 1) at a front end portion 11a. The opening 26 of the housing body 11 can be mated with the male housing 200 (see FIG. 1).

The housing body 11 has the flange portion 24 at the front end portion 11a. The flange portion 24 protrudes from the front end portion 11a of the housing body 11 toward the outside of the housing body 11. The pair of side walls 21 are bilaterally symmetrical members. Hereinafter, the pair of side walls 21 will be described with reference to the right side wall 21, and the description of the left side wall 21 will be omitted. The right side wall 21 will be referred to as a “side wall 21”.

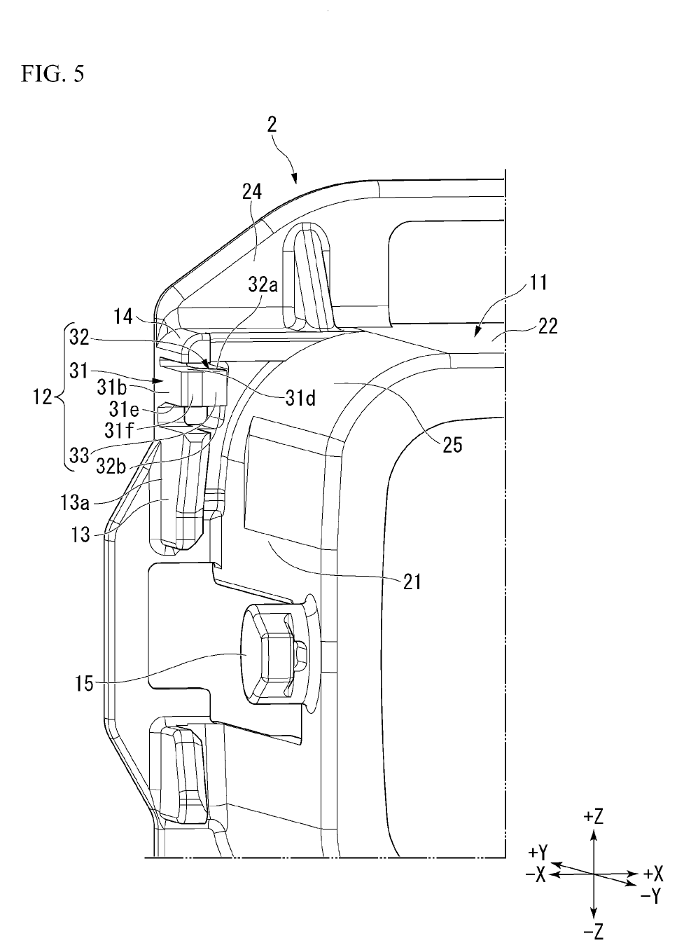

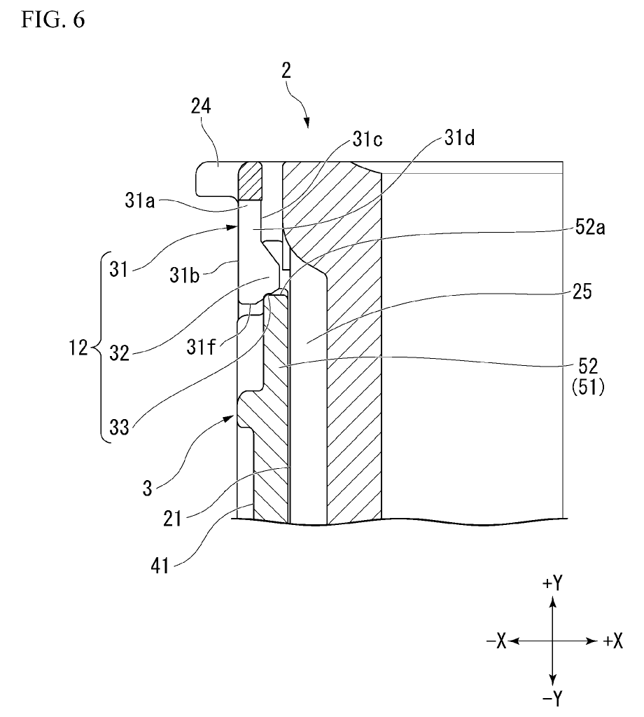

As illustrated in FIGS. 5 and 6, each of the locking arms 12 is provided on the flange portion 24. The locking arm 12 is disposed outside the housing body 11 with a spacing from an intersection portion 25 between the side wall 21 and the top portion 22. The locking arm 12 includes an arm body 31, a locking portion 32, and an inclined surface 33. The arm body 31 extends rearward, for example, from the rear surface of the flange portion 24 along the intersection portion 25. The arm body 31 is an elastically deformable member corresponding to a restricting portion 51 (specifically, a first edge portion 52a) to be described later. The arm body 31 is elastically deformable with the proximal end portion 31a as a fulcrum. The arm body 31 has, for example, an outer surface 31b, an inner surface 31c, an upper surface 31d, and a lower surface 31e. The arm body 31 is formed in a rectangular cross section by, for example, the outer surface 31b, the inner surface 31c, the upper surface 31d, and the lower surface 31e.

For example, the locking portion 32 is integrally provided at the distal end portion of the arm body 31. The locking portion 32 protrudes from the inner surface 31c toward the intersection portion 25 at the distal end portion of the arm body 31. The locking portion 32 protrudes toward the restricting portion 51 to described later. For example, the upper surface 32a of the locking portion 32 is formed to be flush with the upper surface 31d of the arm body 31. For example, the lower surface 32b of the locking portion 32 is formed to be flush with the lower surface 31e of the arm body 31. The inclined surface 33 is provided at the distal end of the locking portion 32. The inclined surface 33 is formed such that the locking portion 32 is tapered toward the distal edge 31f of the arm body 31 in plan view. The inclination angle of the inclined surface 33 can be arbitrarily adjusted.

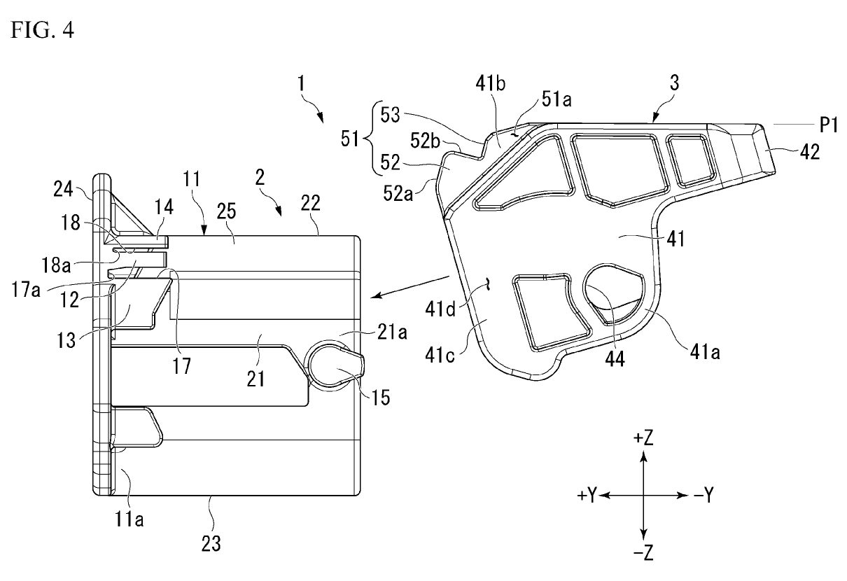

As illustrated in FIGS. 4, 5 and 7, each of the restraining walls 13 is provided on the flange portion 24. The restraining wall 13 extends rearward, for example, from the rear surface of the flange portion 24 along the side wall 21. The restraining wall 13 is, for example, a flat plate-like portion. The restraining wall 13 is disposed with a spacing from the side wall 21 toward the outside of the housing body 11. The restraining wall 13 is disposed below the locking arm 12 with a spacing. That is, the housing 2 has, for example, a first slit (first groove) 17 between the restraining wall 13 and the locking arm 12. The proximal end portion 13a of the restraining wall 13 is disposed continuously with the proximal end portion 31a of the arm body 31 via the flange portion 24.

The restraining wall 13 is located on the side opposite the side wall 21 with respect to the restricting portion 51 to be described later in a state where the lever 3 is disposed at the initial position P2 (see FIG. 3). The restraining wall 13 is disposed so as to overlap the restricting portion 51 (specifically, a first restricting portion 52) in the left-right direction.

As illustrated in FIGS. 4 and 5, for example, each of the stoppers 14 is provided on the flange portion 24 and the intersection portion 25. The stopper 14 extends rearward, for example, from the rear surface of the flange portion 24 along the arm body 31. The stopper 14 is disposed with a spacing from the intersection portion 25 toward the outside of the housing body 11. The stopper 14 is disposed on the side opposite the restraining wall 13 with respect to the locking arm 12 in the vertical direction. The stopper 14 is disposed above the locking arm 12 with a spacing. That is, the housing 2 has, for example, a second slit (second groove) 18 between the restraining wall 13 and the locking arm 12. The bottom portion 18a of the second slit 18 is located rearward in the first axial direction with respect to the bottom portion 17a of the first slit 17.

In the first embodiment, an example in which the bottom portion 18a of the second slit 18 is located rearward with respect to the bottom portion 17a of the first slit 17 will be described, but the present invention is not limited thereto. As another example, for example, the first slit 17 and the second slit 18 may be formed vertically symmetrically with respect to the locking arm 12.

As illustrated in FIGS. 2 to 4, each of the support bosses 15 is provided at the center in the vertical direction at the rear end portion 21a of the side wall 21. The support boss 15 protrudes outward from the center of the rear end portion 21a in the vertical direction. The support boss 15 rotatably supports the lever 3.

### Constitution of Lever

A detailed constitution of the lever 3 will be described.

As illustrated in FIGS. 1 and 4, the lever 3 includes, for example, a pair of leg portions 41 and a connection portion 42. The pair of leg portions 41 is disposed on the left and right sides of the housing body 11. The upper ends of the pair of leg portions 41 are connected by the connection portion 42. The lever 3 has a substantially U shape as the upper ends of the pair of leg portions 41 are connected by the connection portion 42. The pair of leg portions 41 are disposed in a state of interposing the housing body 11 therebetween. The connection portion 42 is, for example, a portion on which an operating force acts when the lever 3 is operated.

The pair of leg portions 41 respectively have support holes 44 (the right support hole 44 is illustrated). Each of the support holes 44 is located at the rear portion 41a of the leg portion 41. The support hole 44 is assembled by being mated with the support boss 15. The lever 3 is rotatably supported by the support bosses 15 (that is, the housing body 11) by assembling the support holes 44 to the support bosses 15. For example, the lever 3 is movable to the assembly position P1 (see FIG. 2), the initial position P2 (see FIG. 3), and the mating position with the support bosses 15 as an axis by applying an operating force to the connection portion 42. The pair of leg portions 41 are bilaterally symmetrical members. Hereinafter, the pair of leg portions 41 will be described with reference to the right leg portion 41, and the description of the left leg portion 41 will be omitted. The right leg portion 41 will be referred to as a “leg portion 41”.

As illustrated in FIGS. 2 to 4, the leg portion 41 includes a restricting portion 51. The restricting portion 51 is disposed at the front portion 41b of the leg portion 41. The support hole 44 is located at the rear portion 41a of the leg portion 41. That is, the restricting portion 51 is located on the opposite side of the support hole 44. The support hole 44 is mated with the support boss 15. With such a constitution, the restricting portion 51 is located on the opposite side of the support hole 44 and the support boss 15.

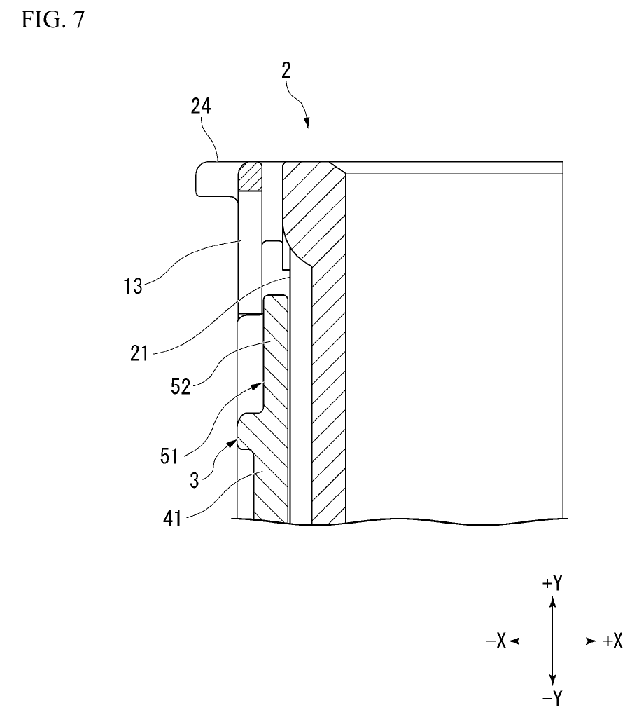

The surface 51a of the restricting portion 51 is a flat surface having a stepped recess on the housing body 11 side with respect to the surface 41d of the main portion 41c in the leg portion 41. The restricting portion 51 can be inserted into a space between the restraining wall 13 and the side wall 21 (see also FIG. 7). The restricting portion 51 can be inserted into a space between the locking arm 12 and the intersection portion 25 (see also FIG. 6). The restricting portion 51 can be inserted into a space between the stopper 14 and the intersection portion 25.

The restricting portion 51 includes a first restricting portion 52 and a second restricting portion 53. The first restricting portion 52 and the second restricting portion 53 are continuously disposed. The first restricting portion 52 has, for example, a first edge portion (edge portion) 52a and a second edge portion (edge portion) 52b. The first edge portion 52a is, for example, disposed with a rearwardly directed gradient toward the upper side in a state where the lever 3 is disposed at the assembly position P1 (see FIG. 4). For example, the first edge portion 52a abuts the inclined surface 33 of the locking arm 12 in a state where the lever 3 is disposed at the assembly position P1 (see FIG. 6). In other words, the inclined surface 33 can abut the first edge portion 52a in a state where the lever 3 is disposed at the assembly position P1.

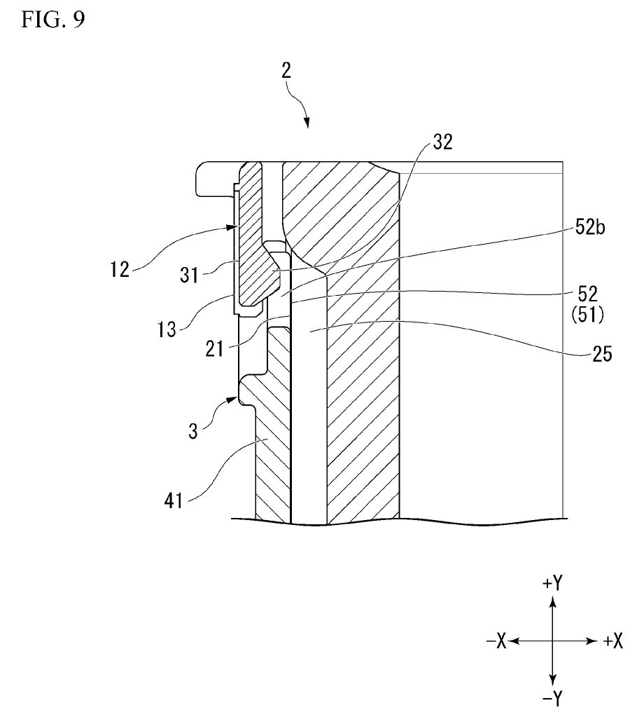

As illustrated in FIGS. 3, 8, and 9, the second edge portion 52b is, for example, disposed horizontally along the first axial direction of the housing 2 in a state where the lever 3 is disposed at the initial position P2. The second edge portion 52b contacts the lower surface 32b of the locking portion 32 in the locking arm 12, for example, in a state where the lever 3 is disposed at the initial position P2. In other words, the locking portion 32 can abut the second edge portion 52b in a state where the lever 3 is disposed at the initial position P2. Since the second edge portion 52b abuts the lower surface 32b of the locking portion 32, the movement of the lever 3 from the initial position P2 to the assembly position P1 can be restricted.

As illustrated in FIGS. 2 to 4, the first edge portion 52a can abut the inclined surface 33 of the locking arm 12. The inclined surface 33 is a surface formed on the locking portion 32. The second edge portion 52b contacts the lower surface 32b of the locking portion 32. The locking portion 32 is located on the opposite side of the support boss 15 and the support hole 44. With such a constitution, it is possible to secure a relatively large distance L1 from the support boss 15 to the inclined surface 33 and the locking portion 32. A distance L2 from the support boss 15 to the connection portion 42 is configured to be substantially the same as the distance L1. The connection portion 42 is, for example, a portion on which an operating force acts when the lever 3 is moved. The distance L1 and the distance L2 will be described in detail later.

### Assembly Procedure of Lever-Type Connector

A representative example of assembling the lever-type connector 1 will be described with reference to FIGS. 1 to 4 and FIGS. 6 to 8. The assembly procedure can be arbitrarily selected. As illustrated in FIG. 4, first, in a state where the lever 3 is disposed at the assembly position P1, the support hole 44 of the lever 3 is mated with the support boss 15 of the housing 2.

As illustrated in FIGS. 2, 6, and 7, in a state where the support hole 44 is mated with the support boss 15, the first restricting portion 52 is inserted into a space between the restraining wall 13 and the side wall 21. The first restricting portion 52 is inserted into the space between the locking arm 12 and the intersection portion 25. The first restricting portion 52 is inserted into the space between the stopper 14 and the intersection portion 25. The first edge portion 52a of the first restricting portion 52 abuts the inclined surface 33 of the locking arm 12. In this state, the lever 3 is assembled at the assembly position P1 of the housing 2.

As illustrated in FIGS. 2 and 6, after the lever 3 is assembled at the assembly position P1, an operating force acts on the connection portion 42 of the lever 3 to move the lever 3 toward the initial position P2. The first edge portion 52a of the first restricting portion 52 abuts the inclined surface 33 of the locking arm 12. With such a constitution, by moving the lever 3 toward the initial position P2, the arm body 31 of the locking arm 12 elastically deforms toward the right outer side of the housing body 11 in response to the first edge portion 52a.

When the arm body 31 elastically deforms, the inclined surface 33 moves along the first edge portion 52a. When the inclined surface 33 moves along the first edge portion 52a, the locking portion 32 rides onto the first restricting portion 52 from the first edge portion 52a. When the locking portion 32 rides onto the first restricting portion 52, the lever 3 can be moved from the assembly position P1 toward the initial position P2.

As illustrated in FIGS. 3, 8, and 9, when the lever 3 is moved to the initial position P2, the locking portion 32 moves above the first restricting portion 52 and disengages from the first restricting portion 52. When the locking portion 32 disengages from the first restricting portion 52, the arm body 31 restores from the elastically deformed state. When the arm body 31 restores, the lower surface 32b of the locking portion 32 contacts the second edge portion 52b of the first restricting portion 52. In this state, the lever 3 is assembled at the initial position P2, and the assembly procedure of the lever-type connector 1 is completed.

As illustrated in FIGS. 1 and 3, in a case where the lever-type connector 1 in which the lever 3 is assembled to the housing 2 is connected to the male housing 200, the opening 26 of the housing 2 is mated with the male housing 200. When the opening 26 of the housing 2 is mated with the male housing 200, the terminal of the housing 2 (not illustrated) is connected to the terminal of the male housing 200 (not illustrated). In a state where the housing 2 is mated with the male housing 200, the lever 3 is moved from the initial position P2 to the mating position. By moving the lever 3 to the mating position, the procedure of connecting the lever-type connector 1 to the male housing 200 is completed.

### Prevention of Disengagement of Lever 3

Next, for example, an example in which the lever 3 is prevented from moving from the initial position P2 to the assembly position P1 due to an erroneous operation will be described with reference to FIGS. 3 and 8 to 10.

As illustrated in FIGS. 3, 8, and 9, in a case where the lever 3 attempts to move from the initial position P2 to the assembly position P1 due to the erroneous operation, the second edge portion 52b of the first restricting portion 52 abuts the lower surface 32b of the locking portion 32. Since the second edge portion 52b abuts the lower surface 32b of the locking portion 32, it is possible to prevent the lever 3 from returning from the initial position P2 to the assembly position P1 due to an erroneous operation. By preventing the lever 3 from returning to the assembly position P1, it is possible to prevent the lever 3 from disengaging from the housing 2 at the assembly position P1.

In a case where the lever 3 attempts to move from the initial position P2 to the assembly position P1 due to the erroneous operation, in the arm body 31, the second edge portion 52b abuts the lower surface 32b of the locking portion 32. It is conceivable that the arm body 31 elastically deforms upward when the second edge portion 52b abuts the lower surface 32b of the locking portion 32. The stopper 14 is disposed above the locking arm 12 with a spacing.

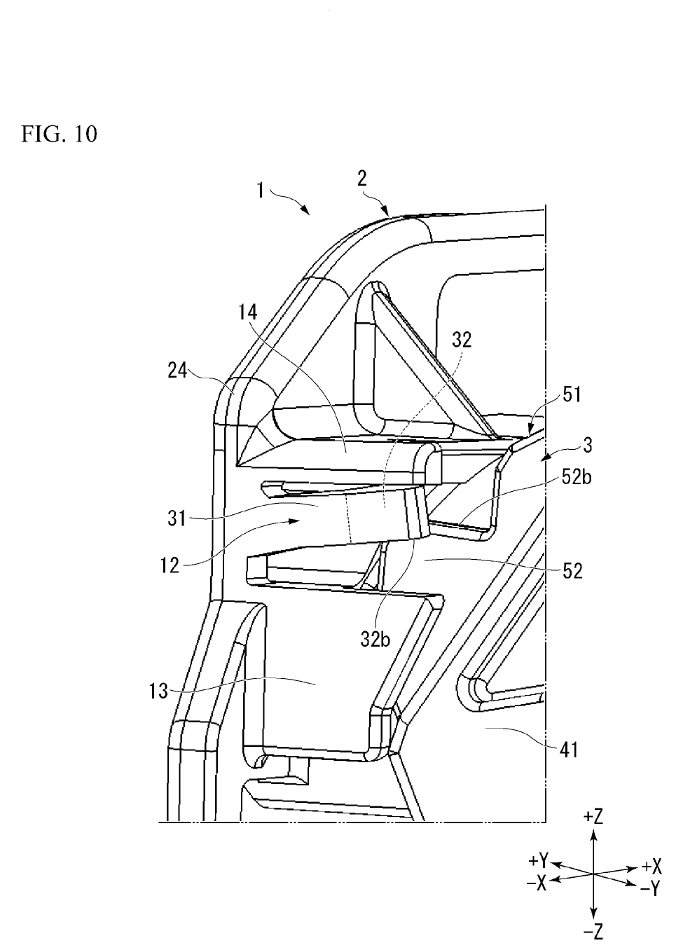

As illustrated in FIG. 10, the arm body 31 can abut the stopper 14 when the arm body 31 elastically deforms upward. The stopper 14 can suppress elastic deformation of the locking arm 12. With such a constitution, it is possible to prevent the lever 3 from returning to the assembly position P1. That is, it is possible to prevent the lever 3 from disengaging from the housing 2 at the assembly position P1.

### Operation and Effects of the Invention

In the lever-type connector 1 according to the first embodiment, as illustrated in FIGS. 2 and 6, the lever 3 includes the restricting portion 51. The housing 2 includes an elastically deformable locking arm 12. The locking arm 12 has the locking portion 32 protruding toward the restricting portion 51. The locking arm 12 has the inclined surface 33 that tapers the locking portion 32. The restricting portion 51 of the lever 3 can be assembled to the housing 2 at the assembly position P1. The inclined surface 33 of the locking portion 32 can abut the first edge portion 52a of the first restricting portion 52 in a state where the lever 3 is disposed at the assembly position P1.

When the lever 3 moves from the assembly position P1 to the initial position P2, the arm body 31 elastically deforms in response to the first edge portion 52a. When the arm body 31 elastically deforms toward the right outer side of the housing body 11, the inclined surface 33 moves on the first edge portion 52a and rides on the first restricting portion 52. The locking portion 32 is movable along the first restricting portion 52 by the inclined surface 33 riding on the first restricting portion 52. The lever 3 is movable from the assembly position P1 to the initial position P2 when the locking portion 32 moves along the first restricting portion 52. With such a configuration, the lever 3 can be assembled to the housing 2 at the assembly position P1 other than the movable region between the initial position P2 (see FIG. 3) and the mating position.

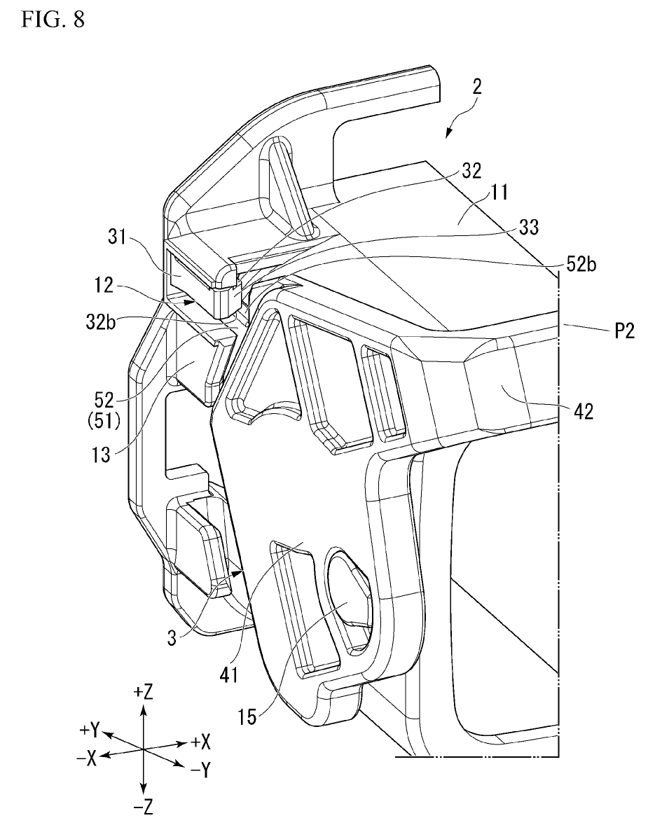

As illustrated in FIGS. 3 and 8, the lower surface 32b of the locking portion 32 can abut the second edge portion 52b of the first restricting portion 52 in a state where the lever 3 is disposed at the initial position P2. When the lower surface 32b of the locking portion 32 abuts the second edge portion 52b, the movement of the lever 3 from the initial position P2 to the assembly position P1 (see FIG. 2) is restricted by the second edge portion 52b and the lower surface 32b of the locking portion 32. That is, the lever 3 is held at the initial position P2. With such a constitution, it is possible to enhance the retention of the lever 3 with respect to the housing 2. Therefore, for example, at the time of work of mating the housing 2 with the male housing 200 (see FIG. 1), the lever 3 can be made difficult to disengage from the housing 2.

As illustrated in FIGS. 3, 8, and 9, the housing 2 includes the restraining wall 13 continuous with the locking arm 12. The restraining wall 13 is disposed in the vicinity of the lower side of the locking arm 12 in the vertical direction. The restraining wall 13 is disposed at a position overlapping the first restricting portion 52 from the opposite side of the side wall 21 of the housing body 11 in a state where the lever 3 is disposed at the initial position P2. With such a constitution, in a case where the operating force returning the lever 3 from the initial position P2 to the assembly position P1 (see FIG. 2) acts on the connection portion 42 of the lever 3, the restraining wall 13 can prevent the first restricting portion 52 from deforming toward the opposite side of the side wall 21. Therefore, the lower surface 32b of the locking portion 32 can stably abut the second edge portion 52b of the first restricting portion 52.

As illustrated in FIGS. 3 and 8, in the arm body 31 of the locking arm 12, in a case where the operating force returning the lever 3 from the initial position P2 to the assembly position P1 (see FIG. 2) acts on the lever 3, the lower surface 32b of the locking portion 32 is pressed upward by the second edge portion 52b of the first restricting portion 52. It is conceivable that the arm body 31 elastically deforms when the lower surface 32b is pressed by the second edge portion 52b. When the arm body 31 elastically deforms, there is a possibility that the lever 3 returns to the assembly position P1.

As illustrated in FIG. 10, the housing 2 includes the stopper 14. The stopper 14 is disposed on the side opposite the restraining wall 13 with respect to the locking arm 12. With such a constitution, the stopper 14 can prevent the arm body 31 from elastically deforming upward in a case where the operating force returning the lever 3 from the initial position P2 to the assembly position P1 acts on the lever 3. Therefore, the arm body 31 can hold the lever 3 at the initial position P2 without increasing the strength.

As illustrated in FIGS. 2 and 6, the arm body 31 does not need to be increased in strength and thus can appropriately deform elastically. With such a configuration, the arm body 31 can appropriately elastically deform in a state where the operating force acting on the connection portion 42 of the lever 3 is suppressed to be small. When the arm body 31 appropriately deforms elastically, the inclined surface 33 can be moved along the second edge portion 52b of the first restricting portion 52. When the inclined surface 33 moves along the second edge portion 52b, the locking portion 32 can ride onto the restricting portion 51. Therefore, the lever 3 is appropriately movable from the assembly position P1 to the initial position P2. The operating force acting on the connection portion 42 of the lever 3 can be adjusted by changing the inclination angle of the inclined surface 33.

As illustrated in FIGS. 2 and 3, the lever 3 has the support hole 44. The support hole 44 is located on the opposite side of the first restricting portion 52. The housing 2 has the support boss 15. The support boss 15 rotatably supports the lever 3 by the support hole 44 being assembled. With such a constitution, the first restricting portion 52 can be disposed relatively largely away from the support boss 15 of the housing 2. The first edge portion 52a of the first restricting portion 52 can abut the inclined surface 33 of the locking arm 12. The second edge portion 52b of the first restricting portion 52 can abut the lower surface 32b of the locking portion 32 in the locking arm 12.

That is, the relatively large distance L1 from the support boss 15 to the inclined surface 33 and the locking portion 32 is secured. Therefore, the lever 3 can appropriately suppress the pressing force transmitted from the first edge portion 52a to the inclined surface 33 in a “leverage ratio” between the distance L1 and the distance L2 from the support boss 15 to the connection portion 42 of the lever 3. The pressing force transmitted from the second edge portion 52b to the lower surface 32b of the locking portion 32 can be appropriately suppressed. With such a constitution, for example, it is possible to appropriately suppress an erroneous movement of the lever 3 from the initial position P2 to the assembly position P1 without increasing the strength of the arm body 31 (that is, the locking arm 12) more than necessary.

### Second Embodiment

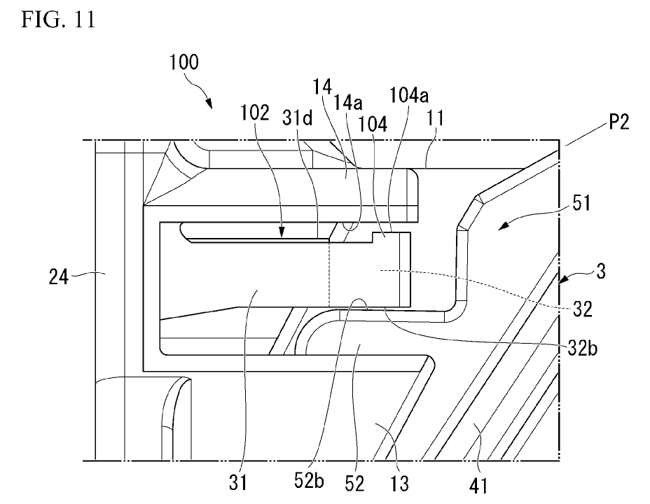

Next, a second embodiment will be described with reference to FIG. 11. In the second embodiment, the same or similar constitution members as those of the first embodiment are denoted by the same reference numbers, and detailed description thereof will be omitted. As illustrated in FIG. 11, a lever-type connector 100 is obtained by replacing the locking arm 12 of the first embodiment with a locking arm 102. Other constitutions of the lever-type connector 100 are similar to those of the lever-type connector 1 of the first embodiment. The locking arm 102 has a protrusion 104. Other constitutions of the locking arm 102 are similar to those of the locking arm 12 of the first embodiment.

The protrusion 104 is integrally provided on the upper surface 31d at the distal end portion of the arm body 31. The protrusion 104 protrudes from the upper surface 31d toward the stopper 14. The upper surface of the protrusion 104 is disposed with a spacing from the stopper 14. The upper surface 104a of the protrusion 104 is formed to be flat along the lower surface 14a of the stopper 14.

In the lever-type connector 100 according to the second embodiment, in a case where the operating force returning the lever 3 from the initial position P2 to the assembly position P1 (see FIG. 2) acts on the connection portion 42 (see FIG. 3) of the lever 3, the second edge portion 52b of the first restricting portion 52 presses the lower surface 32b of the locking portion 32. It is conceivable that the arm body 31 elastically deforms upward when the second edge portion 52b presses the lower surface 32b of the locking portion 32. In a case where the arm body 31 elastically deforms upward, the upper surface 104a of the protrusion 104 abuts the lower surface 14a of the stopper 14.

With such a constitution, the protrusion 104 can adjust the elastic deformation of the arm body 31. Therefore, the protrusion 104 can enhance the retention of the lever 3 to the initial position P2. The protrusion 104 can suppress the variation of the lever 3 at the initial position P2.

In the lever-type connector 100 according to the second embodiment, it is possible to obtain the same operation and effect as those of the lever-type connector 1 according to the first embodiment.

Several embodiments and modification examples have been described above. However, the embodiments and the modification examples are not limited to the examples described above. For example, a plurality of embodiments may be implemented in combination with each other.

### REFERENCE SIGNS LIST

1, 100 Lever-type connector

2 Housing

3 Lever

12, 102 Locking arm

13 Restraining wall

14 Stopper

15 Support Boss

21 Side wall

31 Arm body

32 Locking portion

33 Inclined surface

44 Support hole

51 Restricting portion

52 First restricting portion

52a First edge portion (edge portion)

52b Second edge portion (edge portion)

104 Protrusion

200 Male housing (another housing)

P1 Assembly position

P2 Initial position

What is claimed is:

1. A lever-type connector comprising:
a housing that is capable of being mated with another housing; and
a lever that is assembled to the housing and is movable from an initial position before start of mating with the another housing to a mating position after completion of the mating,
wherein the lever includes a restricting portion that is capable of being assembled to the housing at an assembly position of the housing and is capable of restricting movement from the initial position to the assembly position,
wherein the housing includes a locking arm that is elastically deformable in response to the restricting portion, and
wherein the locking arm includes:
a locking portion that protrudes toward the restricting portion and is capable of abutting an edge portion of the restricting portion in a state where the lever is disposed at the initial position; and
an inclined surface that tapers the locking portion and is capable of abutting the edge portion of the restricting portion in a state where the lever is disposed at the assembly position.

2. The lever-type connector according to claim 1,
wherein the housing includes:
a restraining wall that is disposed continuously with the locking arm; and
overlaps the restricting portion on an opposite side of a side wall of the housing in a state where the lever is disposed at the initial position.

3. The lever-type connector according to claim 2,
wherein the housing includes a stopper that is disposed on an opposite side of the restraining wall with respect to the locking arm.

4. The lever-type connector according to claim 3,
wherein the locking arm includes a protrusion that protrudes toward the stopper.

5. The lever-type connector according to claim 1,
wherein the lever has a support hole located on an opposite side of the restricting portion, and
wherein the housing has a support boss that rotatably supports the lever when the support hole is assembled.
